(19) United States
(12) Patent Application Publication
(10) Pub. No.: US 2026/0277015 A1
(43) Pub. Date: Sep. 17, 2026

(54) Light Field 3D Display Device Based On Time-Sequentially Switched Liquid Crystal Lens Arrays

(71) Applicant: BEIHANG UNIVERSITY, Beijing City (CN)

(72) Inventors: Qionghua WANG, Beijing City (CN); Xuerui WEN, Beijing City (CN); Fan CHU, Beijing City (CN); Yan XING, Beijing City (CN); Xingyu LIN, Beijing City (CN); Yijian LIU, Beijing City (CN); Tianzi SHEN, Beijing City (CN)

(73) Assignee: BEIHANG UNIVERSITY, Beijing City (CN)

(21) Appl. No.: 19/313,507

(22) Filed: Aug. 28, 2025

(30) Foreign Application Priority Data
Mar. 11, 2025 (CN) 202510279728.0

(51) Int. Cl. G02B 30/10

(52) U.S. Cl. CPC G02B 30/10

(57) ABSTRACT

Provided herein is a light field 3D display device based on time-sequentially switched liquid crystal lens arrays, which includes a two-dimensional (2D) display device, a polarization conversion layer, a lower liquid crystal lens array, and an upper liquid crystal lens array. The 2D display device is configured to alternately display a horizontal-direction light field image and a vertical-direction light field image corresponding to different voltage states; the polarization directions of the horizontal-direction light field image and the vertical-direction light field image are controlled by time-sequentially powering on or off of the polarization conversion layer, such that the polarization directions of the two light field images are orthogonal to each other; and the lower liquid crystal lens array is configured to reconstruct the horizontal-direction 3D image, while the upper liquid crystal lens array is configured to reconstruct the vertical-direction 3D image.

### CROSS-REFERENCE TO RELATED APPLICATIONS

This application claims priority under 35 U.S.C. § 119(a) to Chinese Patent Application No. 202510279728.0, filed on Mar. 11, 2025, which is hereby incorporated by reference herein in its entirety.

### TECHNICAL FIELD

The present disclosure relates to the technical field of 3D display, and in particular to a light field 3D display device based on time-sequentially switched liquid crystal lens arrays.

### BACKGROUND ART

Light field three-dimensional (3D) display is considered one of the promising 3D display technologies due to its advantages such as high resolution, quasi-continuous viewing angles, and full-color display. At present, key performance parameters of mainstream light field 3D display devices include 3D image viewing angle, depth, and resolution, which are mutually constrained. Information capacity of the light field 3D display device is difficult to improve, making it impossible to simultaneously improve all performance parameters. Liquid crystal lenses offer benefits in enhancing the performance parameters of 3D display devices due to advantages such as adaptability, focus adjustment without mechanical movement, and compact structure. In order to increase the total information capacity of the light field 3D display devices, researchers at home and abroad have conducted a series of studies using liquid crystal lenses. For example, multi-depth-plane light field 3D display technology based on variable-focus liquid crystal lenses and 2D/3D switchable display based on liquid crystal lenses have been proposed to increase the information capacity of 3D display devices. However, these technologies face challenges such as high system complexity and difficulty in implementation.

### SUMMARY

In order to overcome the deficiencies existing in the prior art, the present disclosure provides a light field 3D display device based on time-sequentially switched liquid crystal lens arrays, which includes a two-dimensional (2D) display device, a polarization conversion layer, a lower liquid crystal lens array, and an upper liquid crystal lens array.

The 2D display device is configured to alternately display a horizontal-direction light field image and a vertical-direction light field image corresponding to different voltage states.

Preferably, light emitted by the 2D display device is linearly polarized light.

The polarization conversion layer is configured to control a polarization direction of linearly polarized light emitted by the 2D display device by time-sequentially powering on or off. The polarization conversion layer includes a lower substrate, a lower transparent planar electrode, a lower alignment layer, a liquid crystal layer, an upper alignment layer, an upper transparent planar electrode, and an upper substrate. The lower transparent planar electrode and the upper transparent planar electrode are made of a transparent conductive material such as indium tin oxide or indium zinc oxide. Thicknesses of the lower transparent planar electrode and the upper transparent planar electrode are the same. The upper transparent planar electrode is grounded, and a voltage is applied to the lower transparent planar electrode.

The lower liquid crystal lens array is configured to reconstruct a horizontal-direction 3D image, and includes a lower substrate, a lower transparent rectangular electrode, a lower alignment layer, a liquid crystal layer, an upper alignment layer, an upper transparent planar electrode, and an upper substrate. The lower transparent rectangular electrode and the upper transparent planar electrode are made of a transparent conductive material such as indium tin oxide or indium zinc oxide. Thicknesses of the lower transparent rectangular electrode and the upper transparent planar electrode are the same. The upper transparent planar electrode is grounded, and a voltage is applied to the lower transparent rectangular electrode. A long edge of the lower transparent rectangular electrode and a short edge of the lower substrate form an angle θ. Rubbing directions of the lower alignment layer and the upper alignment layer are perpendicular to a direction of the long edge of the lower transparent rectangular electrode.

Preferably, a gap l between adjacent lower transparent rectangular electrodes is greater than or equal to 150 micrometers, and a width w of each lower transparent rectangular electrode is less than or equal to 10 micrometers.

The upper liquid crystal lens array is configured to reconstruct a vertical-direction 3D image, and includes a lower substrate, a lower transparent rectangular electrode, a lower alignment layer, a liquid crystal layer, an upper alignment layer, an upper transparent planar electrode, and an upper substrate. The lower transparent rectangular electrode and the upper transparent planar electrode are made of a transparent conductive material such as indium tin oxide or indium zinc oxide. Thicknesses of the lower transparent rectangular electrode and the upper transparent planar electrode are the same. The upper transparent planar electrode is grounded, and a voltage is applied to the lower transparent rectangular electrode. A long edge of the lower transparent rectangular electrode and a long edge of the lower substrate form an angle θ. Rubbing directions of the lower alignment layer and the upper alignment layer are perpendicular to a direction of the long edge of the lower transparent rectangular electrode.

Preferably, a gap l between adjacent lower transparent rectangular electrodes is greater than or equal to 150 micrometers, and a width w of each lower transparent rectangular electrode is less than or equal to 10 micrometers.

Further, the upper substrate of the lower liquid crystal lens array and the lower substrate of the upper liquid crystal lens array are the same substrate.

Further, the upper substrate of the polarization conversion layer and the lower substrate of the lower liquid crystal lens array are the same substrate.

Further, the voltages may be continuously applied to both the lower transparent rectangular electrode of the lower liquid crystal lens array and the lower transparent rectangular electrode of the upper liquid crystal lens array.

Further, the lower substrate of the lower liquid crystal lens array and the lower substrate of the upper liquid crystal lens array are of same dimensions and are overlapped in a horizontal direction.

Further, a time interval during which the 2D display device alternately displays the horizontal-direction light field image and the vertical-direction light field image is less than or equal to a human visual persistence duration.

Further, a time interval during which the 2D display device alternately displays the horizontal-direction light field image and the vertical-direction light field image is the same as a switching time interval of a voltage applied to the polarization conversion layer, and image switching of the 2D display device and voltage switching of the polarization conversion layer are synchronized.

The working principle of light field 3D display device based on time-sequentially switched liquid crystal lens arrays is as follows: during a time period T₁, the 2D display device is configured to display the horizontal-direction light field image, the polarization conversion layer is powered off, and the incident linearly polarized light of the horizontal-direction light field image with the polarization direction A is converted into linearly polarized light with a polarization direction B after passing through the polarization conversion layer, and the light is then refracted by the lower liquid crystal lens array to reconstruct the horizontal-direction 3D image; during a time period T₂, the 2D display device is configured to display the vertical-direction light field image, the polarization conversion layer is powered on, and the incident linearly polarized light of the vertical-direction light field image has the polarization direction A, which remains unchanged after passing through the polarization conversion layer, and the light is then refracted by the upper liquid crystal lens array to reconstruct the vertical-direction 3D image; and during the time periods T₁ and T₂, external voltages are applied to both the upper liquid crystal lens array and the lower liquid crystal lens array, keeping them in working states. The polarization directions A and B are orthogonal to each other.

### BRIEF DESCRIPTION OF THE DRAWINGS

The foregoing aspects and advantages of the present disclosure will become more apparent and readily understood from the following detailed description in conjunction with the accompanying drawings and embodiment, where:

FIG. 1 is a schematic structural diagram of a light field 3D display device based on time-sequentially switched liquid crystal lens arrays according to an embodiment of the present disclosure.

FIG. 2 is a schematic diagram illustrating the generation of a horizontal-direction 3D image of a light field 3D display device based on time-sequentially switched liquid crystal lens arrays according to an embodiment of the present disclosure.

FIG. 3 is a schematic diagram illustrating the generation of a vertical-direction 3D image of a light field 3D display device based on time-sequentially switched liquid crystal lens arrays according to an embodiment of the present disclosure.

FIG. 4 is a schematic structural diagram of a lower liquid crystal lens array.

FIG. 5 is a schematic structural diagram of an upper liquid crystal lens array.

Reference numerals in the aforementioned figures: 1. 2D display device; 2. polarization conversion layer; 3. lower liquid crystal lens array; 4. upper liquid crystal lens array; 101. horizontal-direction light field image; 102. vertical-direction light field image; 103. reconstructed horizontal-direction 3D image; 104. reconstructed vertical-direction 3D image; 201. lower substrate of the polarization conversion layer; 202. lower transparent planar electrode of the polarization conversion layer; 203. lower alignment layer of the polarization conversion layer; 204. liquid crystal layer of the polarization conversion layer; 205. upper alignment layer of the polarization conversion layer; 206. upper transparent planar electrode of the polarization conversion layer; 207. upper substrate of the polarization conversion layer; 301. lower substrate of the lower liquid crystal lens array; 302. lower transparent rectangular electrode of the lower liquid crystal lens array; 303. lower alignment layer of the lower liquid crystal lens array; 304. liquid crystal layer of the lower liquid crystal lens array; 305. upper alignment layer of the lower liquid crystal lens array; 306. upper transparent planar electrode of the lower liquid crystal lens array; 307. upper substrate of the lower liquid crystal lens array; 401. lower substrate of the upper liquid crystal lens array; 402. lower transparent rectangular electrode of the upper liquid crystal lens array; 403. lower alignment layer of the upper liquid crystal lens array; 404. liquid crystal layer of the upper liquid crystal lens array; 405. upper alignment layer of the upper liquid crystal lens array; 406. upper transparent planar electrode of the upper liquid crystal lens array; and 407. upper substrate of the upper liquid crystal lens array.

It should be understood that the above figures are only schematic and not drawn to scale.

### DETAILED DESCRIPTION

A light field 3D display device based on time-sequentially switched liquid crystal lens arrays provided by the present disclosure will be further described below with reference to the embodiments. The following embodiments are merely illustrative of the present disclosure and cannot be understood as a limitation to the scope of protection of the present disclosure. Those skilled in the art may make some non-essential improvements and adjustments according to the contents of the present disclosure, which all fall within the scope of protection of the present disclosure.

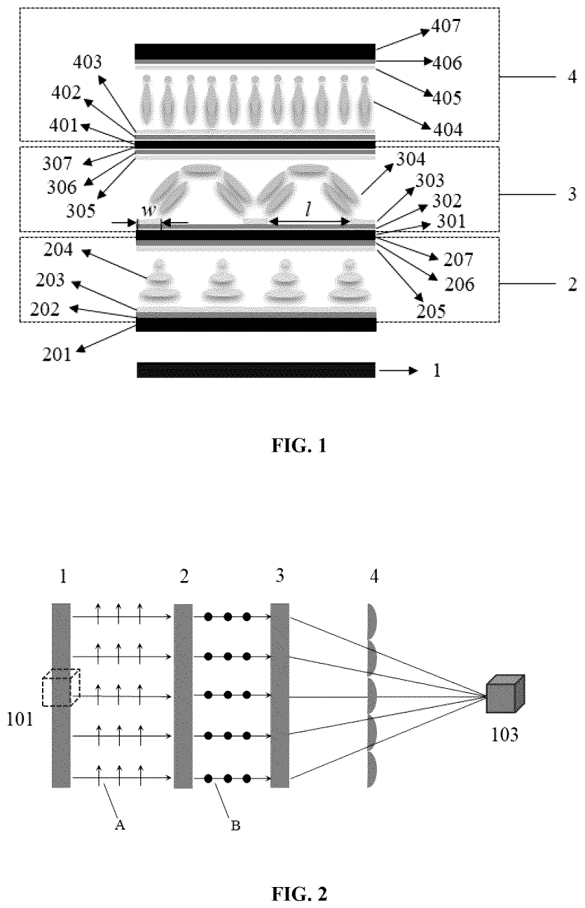

The present disclosure provides a light field 3D display device based on time-sequentially switched liquid crystal lens arrays, as shown in FIG. 1, the display device includes a two-dimensional (2D) display device 1, a polarization conversion layer 2, a lower liquid crystal lens array 3, and an upper liquid crystal lens array 4.

The 2D display device 1 is configured to alternately display a horizontal-direction light field image 101 and a vertical-direction light field image 102 corresponding to different voltage states, as shown in FIGS. 2 and 3. In one embodiment, the 2D display device 1 is a liquid crystal display (LCD) screen having a resolution of 3840× 2160 pixels. Light emitted by the 2D display device 1 is linearly polarized light with a polarization direction A.

The polarization conversion layer 2 is configured to control a polarization direction of linearly polarized light emitted by the 2D display device 1 by time-sequentially powering on or off, as shown in FIG. 1. The polarization conversion layer 2 includes a lower substrate 201, a lower transparent planar electrode 202, a lower alignment layer 203, a liquid crystal layer 204, an upper alignment layer 205, an upper transparent planar electrode 206, and an upper substrate 207. The lower transparent planar electrode 202 and the upper transparent planar electrode 206 are made of a transparent conductive material such as indium tin oxide (ITO) or indium zinc oxide (IZO). Thicknesses of the lower transparent planar electrode 202 and the upper transparent planar electrode 206 are the same. The upper transparent planar electrode 206 is grounded, and a voltage is applied to the lower transparent planar electrode 202. As shown in FIGS. 2 and 3, in one embodiment, when the 2D display device 1 displays the horizontal-direction light field image 101, the emitted linearly polarized light has the polarization direction A. No voltage is applied between the upper transparent planar electrode 206 and the lower transparent planar electrode 202, the linearly polarized light of the horizontal-direction light field image 101 with the polarization direction A is converted into linearly polarized light with a polarization direction B after passing through the polarization conversion layer 2. When the 2D display device 1 displays the vertical-direction light field image 102, the emitted linearly polarized light has the polarization direction A. A voltage is applied between the upper transparent planar electrode 206 and the lower transparent planar electrode 202, the linearly polarized light of the vertical-direction light field image 102 that has the polarization direction A remains unchanged after passing through the polarization conversion layer 2.

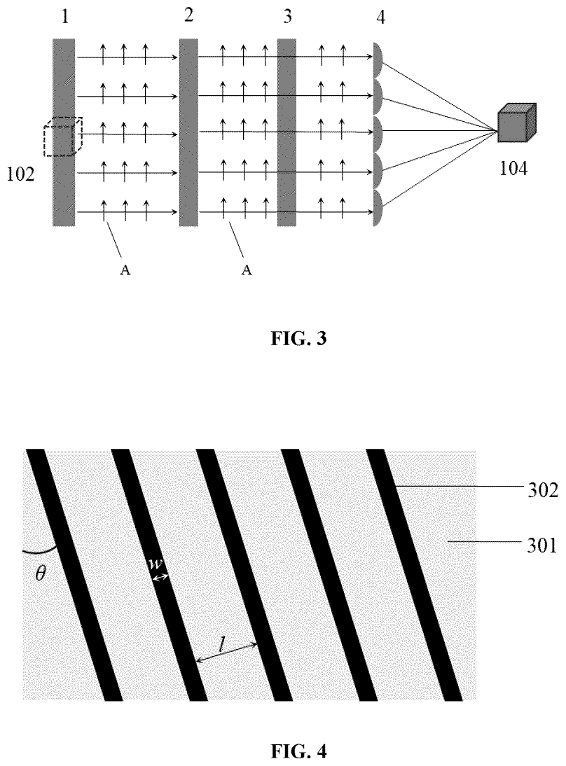

The lower liquid crystal lens array 3 is configured to reconstruct a horizontal-direction 3D image 103, as shown in FIGS. 1 and 2. The lower liquid crystal lens array 3 includes a lower substrate 301, a lower transparent rectangular electrode 302, a lower alignment layer 303, a liquid crystal layer 304, an upper alignment layer 305, an upper transparent planar electrode 306, and an upper substrate 307. The lower transparent rectangular electrode 302 and the upper transparent planar electrode 306 are made of a transparent conductive material such as indium tin oxide (ITO) or indium zinc oxide (IZO). Thicknesses of the lower transparent rectangular electrode 302 and the upper transparent planar electrode 306 are the same. The upper transparent planar electrode 306 is grounded, and a voltage is applied to the lower transparent rectangular electrode 302. A long edge of the lower transparent rectangular electrode 302 and a short edge of the lower substrate 301 form an angle θ. Rubbing directions of the lower alignment layer 303 and the upper alignment layer 305 are perpendicular to a direction of the long edge of the lower transparent rectangular electrode 302. FIG. 4 is a schematic structural diagram of the lower liquid crystal lens array. In one embodiment, the angle θ between the long edge of the lower transparent rectangular electrode 302 and the short edge of the lower substrate 301 is 23°.

Preferably, a gap l between adjacent lower transparent rectangular electrodes 302 is greater than or equal to 150 micrometers, and a width w of each lower transparent rectangular electrode is less than or equal to 10 micrometers. As shown in FIG. 4, in one embodiment, a gap l between adjacent lower transparent rectangular electrodes 302 is 360 micrometers, and a width w of each lower transparent rectangular electrode is 10 micrometers. The lower liquid crystal lens array 3 only exerts a refractive effect on light with the polarization direction B, and does not refract light with the polarization direction A.

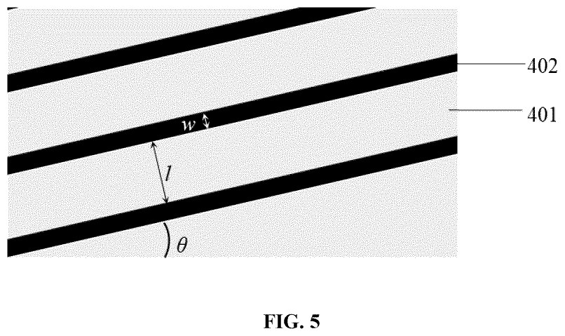

The upper liquid crystal lens array 4 is configured to reconstruct a vertical-direction 3D image 104, as shown in FIGS. 1 and 3. The upper liquid crystal lens array 4 includes a lower substrate 401, a lower transparent rectangular electrode 402, a lower alignment layer 403, a liquid crystal layer 404, an upper alignment layer 405, an upper transparent planar electrode 406, and an upper substrate 407. The lower transparent rectangular electrode 402 and the upper transparent planar electrode 406 are made of a transparent conductive material such as indium tin oxide (ITO) or indium zinc oxide (IZO). Thicknesses of the lower transparent rectangular electrode 402 and the upper transparent planar electrode 406 are the same. The upper transparent planar electrode 406 is grounded, and a voltage is applied to the lower transparent rectangular electrode 402. A long edge of the lower transparent rectangular electrode 402 and a long edge of the lower substrate 401 form an angle θ. Rubbing directions of the lower alignment layer 403 and the upper alignment layer 405 are perpendicular to a direction of the long edge of the lower transparent rectangular electrode 402. FIG. 5 is a schematic structural diagram of the upper liquid crystal lens array. In one embodiment, the angle θ between the long edge of the lower transparent rectangular electrode 402 and the long edge of the lower substrate 401 is 23°.

Preferably, a gap l between adjacent lower transparent rectangular electrodes 402 is greater than or equal to 150 micrometers, and a width w of each lower transparent rectangular electrode is less than or equal to 10 micrometers. As shown in FIG. 5, in one embodiment, a gap l between adjacent lower transparent rectangular electrodes 402 is 360 micrometers, and a width w of each lower transparent rectangular electrode is 10 micrometers. The upper liquid crystal lens array 4 only exerts a refractive effect on light with the polarization direction A, and does not refract light with the polarization direction B.

Further, the upper substrate 307 of the lower liquid crystal lens array 3 and the lower substrate 401 of the upper liquid crystal lens array 4 are the same substrate.

Further, the upper substrate 207 of the polarization conversion layer 2 and the lower substrate 301 of the lower liquid crystal lens array 3 are the same substrate.

Further, the voltages may be continuously applied to both the lower transparent rectangular electrode 302 of the lower liquid crystal lens array 3 and the lower transparent rectangular electrode 402 of the upper liquid crystal lens array 4.

Further, the lower substrate 301 of the lower liquid crystal lens array 3 and the lower substrate 401 of the upper liquid crystal lens array 4 are of same dimensions and are overlapped in a horizontal direction. In one embodiment, the lower substrate 301 of the lower liquid crystal lens array 3 and the lower substrate 401 of the upper liquid crystal lens array 4 both have dimensions of 18 centimeters×18 centimeters.

Further, a time interval during which the 2D display device 1 alternately displays the horizontal-direction light field image 101 and the vertical-direction light field image 102 is less than or equal to a human visual persistence duration. The human visual persistence duration refers to a duration determined based on visual inertia of a human eye. The visual inertia is a key characteristic of the human eye, that is, when an image is formed on a retina, the image formed on the retina by the human eye persists for a limited period of time, which is known as the human visual persistence duration and falls in a range of about 0.05-0.2 seconds. In one embodiment, the time interval is 16.67 milliseconds.

Further, a time interval during which the 2D display device 1 alternately displays the horizontal-direction light field image 101 and the vertical-direction light field image 102 corresponding to different voltage states is the same as a switching time interval of a voltage applied to the polarization conversion layer 2, and image switching of the 2D display device and voltage switching of the polarization conversion layer are synchronized. In one embodiment, a switching interval of a voltage applied to the polarization conversion layer 2 is 16.67 milliseconds.

A specific implementation process of the light field 3D display device based on time-sequentially switched liquid crystal lens arrays provided in the present disclosure is as follows:
during a time period T₁, the 2D display device 1 displays the horizontal-direction light field image 101, the polarization conversion layer 2 is powered off, and the incident linearly polarized light of the horizontal-direction light field image 101 with the polarization direction A is converted into linearly polarized light with a polarization direction B after passing through the polarization conversion layer 2, and the light is then refracted by the lower liquid crystal lens array 3 to reconstruct the horizontal-direction 3D image 103; during a time period T₂, the 2D display device 1 displays the vertical-direction light field image 102, the polarization conversion layer 2 is powered on, and the incident linearly polarized light of the vertical-direction light field image 102 has the polarization direction A, which remains unchanged after passing through the polarization conversion layer 2, and the light is then refracted by the upper liquid crystal lens array 4 to reconstruct the vertical-direction 3D image 104; and during both time periods T₁ and T₂, external voltages are applied to both the lower liquid crystal lens array 3 and the upper liquid crystal lens array 4, keeping them in working states. The polarization directions A and B are orthogonal to each other.

The present disclosure adopts a time-division multiplexing method to achieve fusion display of two sets of stereoscopic images: horizontal-direction stereoscopic image and vertical-direction stereoscopic image, thereby increasing the total information capacity of the light field 3D display device.

The foregoing description is merely illustrative of preferred embodiments of the present disclosure and should not be construed as limiting the scope of protection of the present disclosure. Therefore, equivalent modifications and substitutions within the scope of the appended claims shall fall within the scope of the present disclosure.

What is claimed is:

1. A light field 3D display device based on time-sequentially switched liquid crystal lens arrays, comprising a two-dimensional (2D) display device, a polarization conversion layer, a lower liquid crystal lens array, and an upper liquid crystal lens array; wherein
the 2D display device is configured to alternately display a horizontal-direction light field image and a vertical-direction light field image corresponding to different voltage states;
the polarization conversion layer is configured to control a polarization direction of linearly polarized light emitted by the 2D display device by time-sequentially powering on or off;
the lower liquid crystal lens array is configured to reconstruct a horizontal-direction 3D image; and
the upper liquid crystal lens array is configured to reconstruct a vertical-direction 3D image.

2. The light field 3D display device based on time-sequentially switched liquid crystal lens arrays of claim 1, wherein the polarization conversion layer comprises a lower substrate, a lower transparent planar electrode, a lower alignment layer, a liquid crystal layer, an upper alignment layer, an upper transparent planar electrode, and an upper substrate; and the upper transparent planar electrode is grounded, and a voltage is applied to the lower transparent planar electrode.

3. The light field 3D display device based on time-sequentially switched liquid crystal lens arrays of claim 1, wherein the lower liquid crystal lens array comprises a lower substrate, a lower transparent rectangular electrode, a lower alignment layer, a liquid crystal layer, an upper alignment layer, an upper transparent planar electrode, and an upper substrate; the upper transparent planar electrode is grounded, and a voltage is applied to the lower transparent rectangular electrode; and a long edge of the lower transparent rectangular electrode and a short edge of the lower substrate form an angle (θ), and rubbing directions of the lower alignment layer and the upper alignment layer are perpendicular to a direction of the long edge of the lower transparent rectangular electrode.

4. The light field 3D display device based on time-sequentially switched liquid crystal lens arrays of claim 1, wherein the upper liquid crystal lens array comprises a lower substrate, a lower transparent rectangular electrode, a lower alignment layer, a liquid crystal layer, an upper alignment layer, an upper transparent planar electrode, and an upper substrate; the upper transparent planar electrode is grounded, and a voltage is applied to the lower transparent rectangular electrode; and a long edge of the lower transparent rectangular electrode and a long edge of the lower substrate form an angle (θ), and rubbing directions of the lower alignment layer and the upper alignment layer are perpendicular to a direction of the long edge of the lower transparent rectangular electrode.

5. The light field 3D display device based on time-sequentially switched liquid crystal lens arrays of claim 1, wherein a time interval during which the 2D display device alternately displays the horizontal-direction light field image and the vertical-direction light field image is less than or equal to a human visual persistence duration.

6. The light field 3D display device based on time-sequentially switched liquid crystal lens arrays of claim 1, wherein the time interval during which the 2D display device alternately displays the horizontal-direction light field image and the vertical-direction light field image is the same as a switching time interval of a voltage applied to the polarization conversion layer, and image switching of the 2D display device and voltage switching of the polarization conversion layer are synchronized.

7. The light field 3D display device based on time-sequentially switched liquid crystal lens arrays of claim 1, wherein during a time period (T₁), the 2D display device is configured to display the horizontal-direction light field image, the polarization conversion layer is powered off, and incident linearly polarized light of the horizontal-direction light field image with a polarization direction (A) is converted into linearly polarized light with a polarization direction (B) after passing through the polarization conversion layer, and is then refracted by the lower liquid crystal lens array to reconstruct the horizontal-direction 3D image; during a time period (T₂), the 2D display device is configured to display the vertical-direction light field image, the polarization conversion layer is powered on, and incident linearly polarized light of the vertical-direction light field image has the polarization direction (A), the polarization direction remains unchanged after passing through the polarization conversion layer, and the incident linearly polarized light is then refracted by the upper liquid crystal lens array to reconstruct the vertical-direction 3D image; during the time period (T₁) and the time period (T₂), external voltages are applied to both the upper liquid crystal lens array and the lower liquid crystal lens array, such that the lower liquid crystal lens array and the upper liquid crystal lens array are in working states; and the polarization direction (A) and the polarization direction (B) are orthogonal to each other.
